(19) United States
(12) Patent Application Publication
(10) Pub. No.: US 2014/0337881 A1
(43) Pub. Date: Nov. 13, 2014

(54) METHOD, NON-TRANSITORY COMPUTER-READABLE STORAGE MEDIUM, AND SYSTEM FOR PRODUCING AND PLAYING PERSONALIZED VIDEO

(71) Applicant: Feltmeng Inc., Taipei City (TW)

(72) Inventors: Hsin-Jen Huang, Taipei City (TW); Zhi-Hong Zhu, Taipei City (TW); You-Lin Hsieh, Taipei City (TW); Chin-Chi Lo, Taipei City (TW)

(73) Assignee: Feltmeng Inc., Taipei City (TW)

(21) Appl. No.: 13/892,317

(22) Filed: May 13, 2013

(51) Int. Cl. H04N 21/458; H04N 21/61; H04N 21/81; H04N 21/435

(52) U.S. Cl. CPC H04N 21/458; H04N 21/435; H04N 21/6175; H04N 21/812
USPC 725/34

(57) ABSTRACT

A method of producing and playing a personalized video includes producing a plurality of video templates according to contents of a plurality of videos; inserting a personalized content into a video template among the plurality of video templates, in order to generate the personalized video; playing the personalized video on a digital out of home (DOOH) among a plurality of DOOHs or a television (TV) broadcasting medium among a plurality of TV broadcasting media; announcing time and location of playing the personalized video on at least one social networking website or a channel of the TV broadcasting medium in advance before the DOOH or the TV broadcasting medium plays the personalized video; and delivering the personalized video on the social networking website simultaneously or after a specific period of time when the personalized video is played by the DOOH or the TV broadcasting medium.

### BACKGROUND OF THE INVENTION

1. Field of the Invention

The present invention relates to a method, a non-transitory computer-readable storage medium, and a system for producing and playing a personalized video, and more particularly, to a method, a non-transitory computer-readable storage medium, and a system capable of generating a personalized video by inserting a personalized content into a video template, and playing the personalized video on a digital out of home (DOOH) or a television (TV) broadcasting medium.

2. Description of the Prior Art

With the advancement of electronic information transmission and displaying technologies, television (TV) broadcasting media and digital out of homes (DOOHs) have been widely used for distributing information. The TV broadcasting medium transmits video content to a TV in the house via a wired or wireless network, with which the content is broadcasted to a large audience watching the TV at the same time. Digital signages of the DOOHs are usually installed in public areas where crowds of people gather. The digital signages are capable of playing rich video and text contents on big-size screens so that crowds can watch the digital signage simultaneously; in other words, the digital signages “narrowcast” to the crowds. Since the audience watches the content of the DOOH together, they may easily influence each other. For example, when seeing a large number of people standing and staring at something, a pedestrian passing by may also stop and take a look at it (to figure out what happened).

The characteristics of “broadcasting” of the TV medium and “narrowcasting” and “crowd gathering” of the DOOHs make these media superior tools for advertising. Because of certain technical limitations, however, most advertisements on the TV broadcasting medium and DOOHs are confined to predefined videos and images, which can only be played in turn repeatedly. The effectiveness of such one-way dissemination is therefore limited.

Moreover, although the TV broadcasting medium has the characteristic of “broadcasting” and the DOOHs have the characteristics of “narrowcasting” and “crowd gathering”, the advertisements played thereof are often “commercial-oriented” (rather than “content-oriented”). Very soon people are tired of watching them, and ignore them eventually.

In recent years, social networking platforms (e.g. Facebook, Twitter, etc.) have become increasingly popular. The social networking platforms allow personal content to be transmitted selectively to those who may be interested (e.g. relatives, friends, fans, etc.) via apps or browsers in mobile phones or tablets. Since the contents are more closely linked to the audience, related information is more likely to be accepted, and then effectively consumed.

Although social medium is an efficient way of sharing the contents, the commercial-oriented advertisements produced by advertisers cannot always be broadcasted in this way. The reason is that the contents of commercial advertisements are always designed for wide audience to receive information with particular purposes, but the contents which are being put on social network platforms are normally “personalized” to a certain extent. (For example, people may only want to share some specific contents via the social network if these contents are “related to themselves” or they think “their friends are interested in them”.) “Personalization” is therefore inconsistent with the concept of commercial advertising. If personalized elements were to be combined with commercial advertisements, the whole content would need to be properly designed and controlled.

Thus, there is a need for a system which combines “social networking” with “DOOHs” or the conventional “TV broadcasting medium”, in order to compensate for the shortcomings of each other.

### SUMMARY OF THE INVENTION

It is therefore an objective of the present invention to provide a method, a non-transitory computer-readable storage medium and a system for producing and playing a personalized video, which is capable of combining the “social networking” with the “digital out of homes (DOOHs)” or the “television (TV) broadcasting medium”, in order to compensate for the shortcomings of each other. The present invention provides a user interface for performing customization. A user can insert customized content into several specific objects in advertisement videos. Then, the customized videos are played on the DOOHs or the TV broadcasting media, and shared on a social networking platform simultaneously or after a specific period of time. The present invention personalizes the advertisement content on the DOOHs or the TV broadcasting media. The effectiveness of the advertisements are enhanced significantly due to such diversification of the content (e.g. each time an advertisement is played, different content with different original features contributed by different users is broadcast, so that people may want to watch the advertisement again) and resonance of the audience (e.g. people want to watch an advertisement when a face of their friends appears in it). The present invention may also link an individual with a commercial advertisement, so that the individual will be interested in broadcasting the advertisement content through its social networks; that is, the mechanism of the present invention makes the audience more willing to distribute the advertisement because they are involved in this advertisement played on the mass media. Information of the advertisement is therefore transferred more accurately (to right target audience), which further enhances the effectiveness.

The present invention discloses a method of producing and playing a personalized video. The method comprises producing a plurality of video templates according to contents of a plurality of videos; storing information corresponding to a plurality of digital out of homes (DOOHs) or a plurality of television (TV) broadcasting media, and information corresponding to the plurality of video templates in a memory; inserting a personalized content into a video template among the plurality of video templates according to the information corresponding to the plurality of video templates, in order to generate the personalized video; playing the personalized video on a DOOH among the plurality of DOOHs or a TV broadcasting medium among the plurality of TV broadcasting media according to the information corresponding to the plurality of DOOHs or the plurality of TV broadcasting media; announcing time and location of playing the personalized video on at least one social networking website or a channel of the TV broadcasting medium in advance before the DOOH or the TV broadcasting medium plays the personalized video; and delivering the personalized video on the social networking website simultaneously or after a specific period of time when the personalized video is played by the DOOH or the TV broadcasting medium.

The present invention further discloses a non-transitory computer-readable storage medium having a program instructed by a processor to execute a method of producing and playing a personalized video. The method comprises producing a plurality of video templates according to contents of a plurality of videos; storing information corresponding to a plurality of digital out of homes (DOOHs) or a plurality of television (TV) broadcasting media, and information corresponding to the plurality of video templates in a memory; inserting a personalized content into a video template among the plurality of video templates according to the information corresponding to the plurality of video templates, in order to generate the personalized video; playing the personalized video on a DOOH among the plurality of DOOHs or a TV broadcasting medium among the plurality of TV broadcasting media according to the information corresponding to the plurality of DOOHs or the plurality of TV broadcasting media; announcing time and location of playing the personalized video on at least one social networking website or a channel of the TV broadcasting medium in advance before the DOOH or the TV broadcasting medium plays the personalized video; and delivering the personalized video on the social networking website simultaneously or after a specific period of time when the personalized video is played by the DOOH or the TV broadcasting medium.

The present invention further discloses a system for producing and playing a personalized video. The system comprises a template producing tool, for producing a plurality of video templates according to contents of a plurality of videos; a memory, for storing information corresponding to a plurality of digital out of homes (DOOHs) or a plurality of television (TV) broadcasting media, and information corresponding to the plurality of video templates in a memory; a processor; and a storage media, having a program instructed by the processor to execute the following steps: inserting a personalized content into a video template among the plurality of video templates according to the information corresponding to the plurality of video templates in order to generate the personalized video, playing the personalized video on a DOOH among the plurality of DOOHs or a TV broadcasting medium among the plurality of TV broadcasting media according to the information corresponding to the plurality of DOOHs or the plurality of TV broadcasting media, announcing time and location of playing the personalized video on at least one social networking website or a channel of the TV broadcasting medium in advance before the DOOH or the TV broadcasting medium plays the personalized video, and delivering the personalized video on the social networking website simultaneously or after a specific period of time when the personalized video is played by the DOOH or the TV broadcasting medium.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a network environment realizing a system for producing and playing a personalized video according to an embodiment of the present invention.

FIG. 2 is a schematic diagram of a personalized video producing and playing process according to an embodiment of the present invention.

FIG. 3 is a schematic diagram of a keyframe in the video according to an embodiment of the present invention.

FIG. 4 is a schematic diagram of a video template user interface according to an embodiment of the present invention.

FIG. 5 is a schematic diagram of a video producing interface according to an embodiment of the present invention.

FIG. 6 is a schematic diagram of inserting a personalized content into a customizable object in the keyframe shown in FIG. 3 according to an embodiment of the present invention.

FIG. 7 is a schematic diagram of a map according to an embodiment of the present invention.

### DETAILED DESCRIPTION

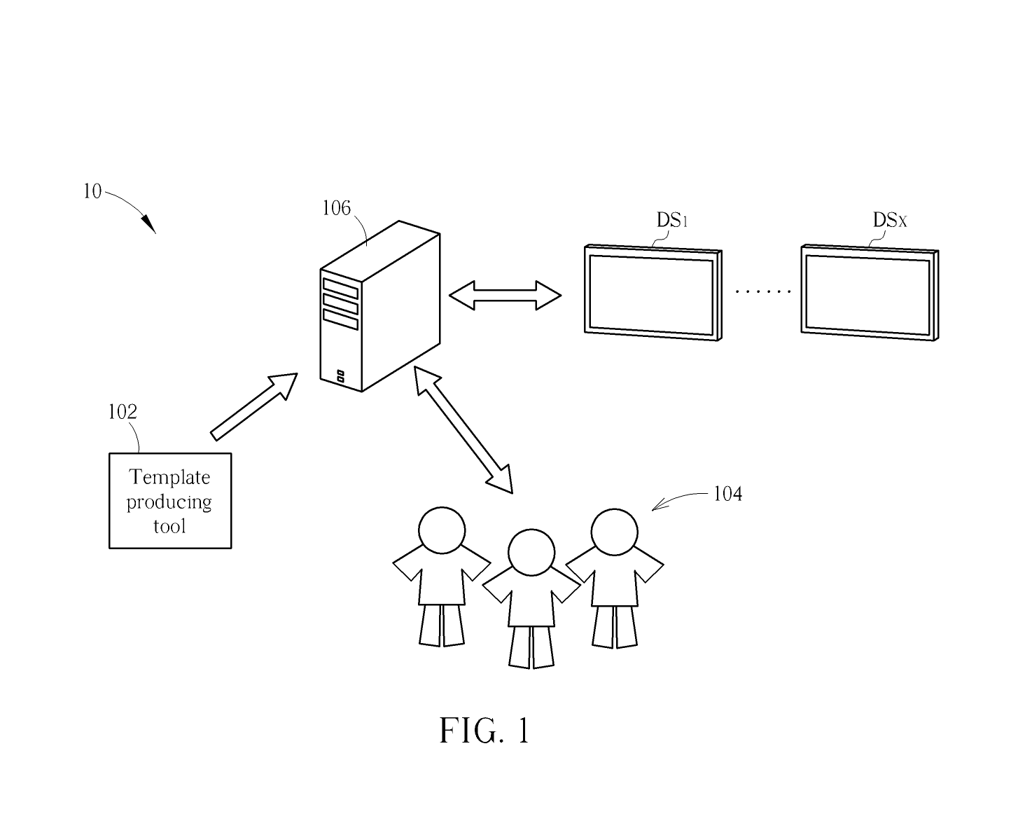

Please refer to FIG. 1, which is a schematic diagram of a network environment 10 realizing a system for producing and playing a personalized video according to an embodiment of the present invention. As shown in FIG. 1, the network environment 10 includes a template producing tool 102, at least one user 104, a server 106 and digital out of homes (DOOHs) or television (TV) broadcasting media DS₁-DS_{X}. The network environment 10 may be a local, proprietary network (e.g. an intranet), and/or a part of a wide area network (WAN). The network environment 10 may also be a local area network (LAN), which may be communicatively coupled to a WAN such as the Internet. The network environment 10 may also be a combination of different types of networks; this is not limited herein. The spirit of the network environment 10 is to provide a platform for members of the network environment 10 to communicate with each other.

The template producing tool 102 is utilized for producing a plurality of video templates VT₁-VT_{N} according to contents of a plurality of videos. The complete video templates VT₁-VT_{N} are transmitted to the server 106 and stored in a memory of the server 106. The memory for storing the video templates VT₁-VT_{N} may also be realized in the template producing tool 102 or realized alone in the network environment 10, which is not limited herein. The user 104 may utilize any numbers of different electronic devices such as a mobile phone, smart phone, personal digital assistant (PDA), portable computer (e.g. laptop, netbook and tablet), personal computer (PC) or any other types of communication devices which can be utilized in the network environment 10. The user 104 may communicate with the server 106 via the network environment 10, in order to obtain information related to producing and playing the personalized video, so that the user 104 can produce the personalized video based on his/her personal requirements. The user 104 may also control a processor in the server 106 to select the desired DOOHs or TV broadcasting media DS₁-DS_{X} for playing the personalized video and the method of playing the video. The server 106 may be utilized for storing the video templates VT₁-VT_{N} and its related information, and also for storing information related to the DOOHs or TV broadcasting media DS₁-DS_{X} such as location, playing scheduling, etc. In some embodiments, the server 106 may be utilized for managing the playing scheduling for each of the DOOHs or TV broadcasting media DS₁-DS_{X}.

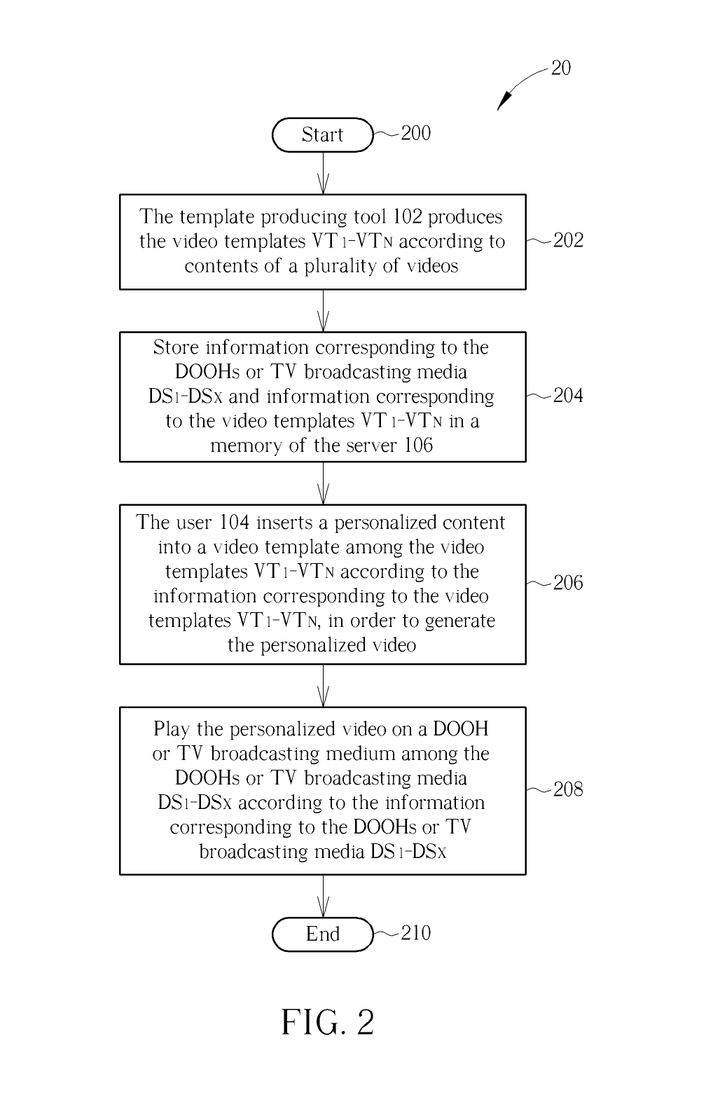

Please refer to FIG. 2, which is a schematic diagram of a personalized video producing and playing process 20 according to an embodiment of the present invention. The personalized video producing and playing process 20 can be compiled into programs realized in the template producing tool 102, the user 104 and the server 106, and includes the following steps:

Step 200: Start.

Step 202: The template producing tool 102 produces the video templates VT₁-VT_{N} according to contents of a plurality of videos.

Step 204: Store information corresponding to the DOOHs or TV broadcasting media DS₁-DS_{X} and information corresponding to the video templates VT₁-VT_{N} in a memory of the server 106.

Step 206: The user 104 inserts a personalized content into a video template among the video templates VT₁-VT_{N} according to the information corresponding to the video templates VT₁-VT_{N}, in order to generate the personalized video.

Step 208: Play the personalized video on a DOOH or TV broadcasting medium among the DOOHs or TV broadcasting media DS₁-DS_{X} according to the information corresponding to the DOOHs or TV broadcasting media DS₁-DS_{X}.

Step 210: End.

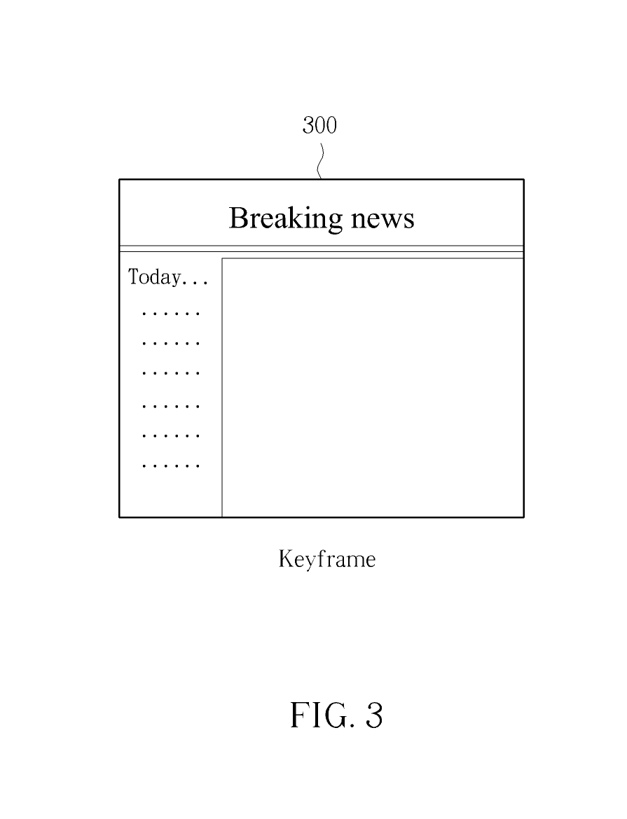

According to the personalized video producing and playing process 20, the template producing tool 102 first produces the video templates VT₁-VT_{N} according to the contents of the plurality of videos. These videos may be any kind of video with digital formats such as advertisements, movies, short films, etc. The template producing tool 102 may retrieve raw data of the video, where the raw data may include images, figures, sounds, words, etc. In the raw data, the video information may be interpreted as frames corresponding to different times in a timeline and location and size of each object (e.g. image, figure, sound, word) in each frame. Each frame is played continuously as time goes on. A keyframe, which is a specific frame selected by the template designer, is capable of unfolding customizable objects defined in the template. For an illustration of this, please refer to FIG. 3, which is a schematic diagram of a keyframe 300 in the video. As shown in FIG. 3, the keyframe 300 illustrates a part of a newspaper, which includes a picture. The content of this picture is hollowed out, which means that this picture is set to be an object allowing the user 104 to insert the personalized content. In the same section of a video, there may be one or more keyframes allowing the user 104 to insert the personalized content. Besides, in the same keyframe, there may be one or more objects allowing the user 104 to insert the personalized content.

After the video template is accomplished, it may be uploaded to the server 106 and stored in the memory. In addition, a description file corresponding to the video template may also be uploaded to the server 106 and stored in the memory. The description file of the video template describes information related to the keyframes and objects capable of inserting the personalized content in the video template. The description file may include location of each keyframe on the timeline, location of each object in each keyframe, size of each object, etc.

In some embodiments, the template producing tool 102 may be Adobe After Effects, and the objects of the video template are considered as footage (images, videos, sounds) and text layer (words) in After Effects. The description file of the video template may describe which footage and text layer are customizable objects allowing the user to insert the personalized content.

The memory in the server 106 stores not only the video templates VT₁-VT_{N} and the corresponding description files, but also the DOOHs or TV broadcasting media DS₁-DS_{X} and the corresponding information. The information corresponding to the DOOHs or TV broadcasting media DS₁-DS_{X} includes names, locations, size and playing schedules of the DOOHs or TV broadcasting media DS₁-DS_{X}. In some embodiments, the information corresponding to the DOOHs or TV broadcasting media DS₁-DS_{X} may include a frequency of audiences passing through the viewing area of a specific DOOH. The server 106 may be connected to the DOOHs or TV broadcasting media DS₁-DS_{X}. When the user 104 needs to play the video, the server 106 may control one or more specific DOOHs or TV broadcasting media among the DOOHs or TV broadcasting media DS₁-DS_{X} to play the video.

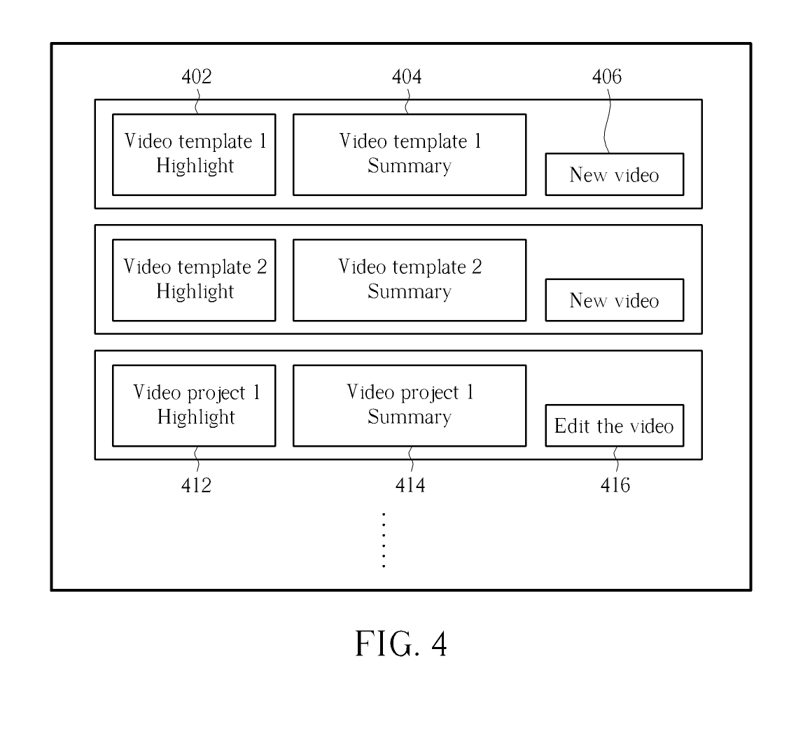

When the user 104 needs to produce a personalized video, the user 104 may select any one of the video templates VT₁-VT_{N} to insert the personalized content. Please refer to FIG. 4, which is a schematic diagram of a video template user interface 40 according to an embodiment of the present invention. As shown in FIG. 4, information related to all selectable videos is displayed in the video template user interface 40. In one embodiment, the information displayed in the video template user interface 40 includes a video template highlight 402 and a video template summary 404. The user 104 may select the desired video template in order to insert the personalized content according to the video template highlight 402 and the video template summary 404, and click a new video button 406 to enter a video producing interface. The personalized video which has been started processing can be considered as a video project. The video template user interface 40 further includes a video project highlight 412 and a video project summary 414 corresponding to the video project that is occurring. The user 104 may click an editing video button 416 to continue processing this video project.

In some embodiments, the video templates VT₁-VT_{N} may be classified based on different applications. For example, the video templates VT₁-VT_{N} may be divided into a video template for proposing, a video template for birthday celebration, etc. At this point, the user 104 may first select the type of video template, and then select the desired video template from among the selected types to insert the personalized content.

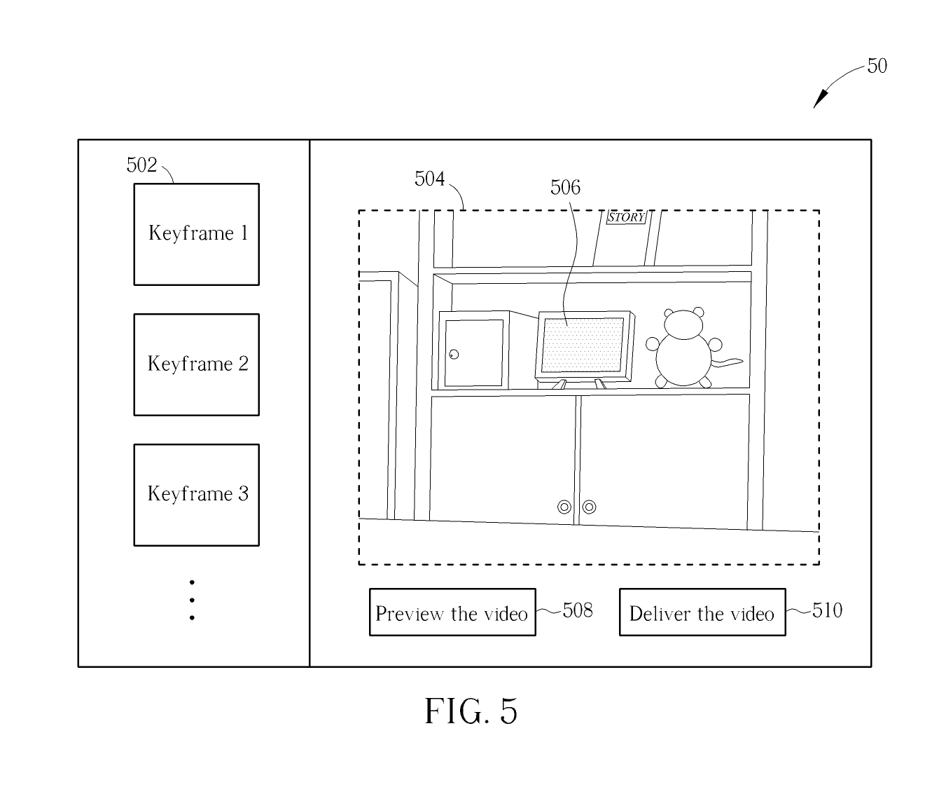

Please refer to FIG. 5, which is a schematic diagram of a video producing interface 50 according to an embodiment of the present invention. As shown in FIG. 5, after the user 104 enters the video producing interface 50, at least one keyframe 502 and an editing area 504 are displayed on the screen. The keyframe 502 displays all keyframes allowing insertion of the personalized content in the video. When the user 104 clicks any one of the keyframes 502, a corresponding image may be displayed in the editing area 504. The editing area 504 displays customizable objects 506 in the keyframe 502, and the user 104 may insert the personalized content in the customizable objects 506. The information related to the keyframe 502 and the customizable objects 506 may be obtained in the description file of the video template. In some embodiments, the video producing interface 50 further provides a preview button 508 and a delivering button 510. During the process of editing the personalized video, the user 104 may click the preview button 508 to preview the video. After the personalized video is accomplished, the user 104 may click the delivering button 510 to deliver the video.

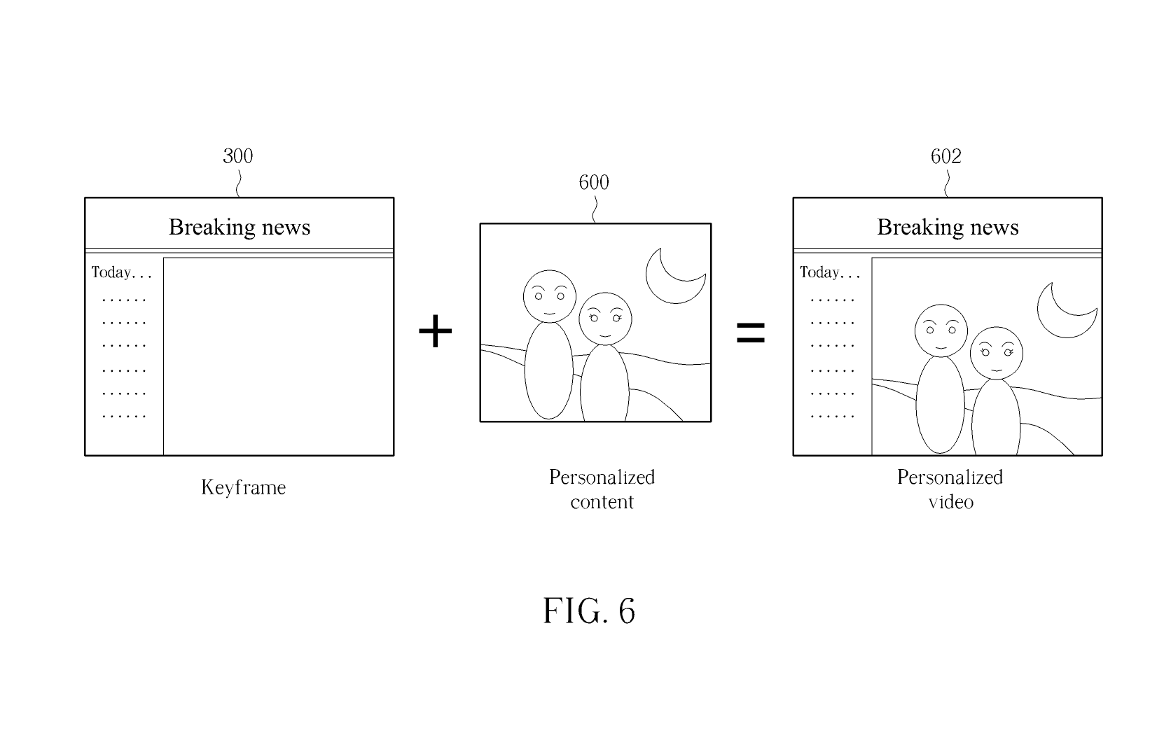

The personalized contents inserted into the customizable objects 506 in the keyframe 502 may be photos, videos, sounds, words, etc. A photo insertion is taken as an example. Please refer to FIG. 6, which is a schematic diagram of inserting a personalized content 600 into a customizable object in the keyframe 300 shown in FIG. 3 according to an embodiment of the present invention. As shown in FIG. 6, after the personalized content 600 is inserted into the customizable object in the keyframe 300, a personalized video 602 with the combination of the video content and the personalized content will be obtained.

After the personalized video is accomplished, the user 104 may start to deliver the personalized video. In some embodiments, when the DOOHs are used for playing the video, the user 104 may enter an interface for DOOH overview. After the user 104 selects the desired country/city for playing the video, a map of this country/city may be displayed on the screen. The user 104 designates an area for playing the video from the map of the country/city, and the DOOHs in the designated area will then be displayed on the screen, in order to allow the user 104 to perform the selection. In some embodiments, when the TV broadcasting media are used for playing the video, the user 104 may select a TV broadcasting channel and time for playing the video. In some embodiments, global positioning satellite (GPS) may be utilized for detecting the location of the user 104, and the DOOHs nearby can be displayed directly, in order to allow the user 104 to perform the selection. In some embodiments, the map may not be utilized, and a list of the DOOHs or TV broadcasting media is provided for the user 104 to select the desired DOOH or TV broadcasting medium for playing the personalized video.

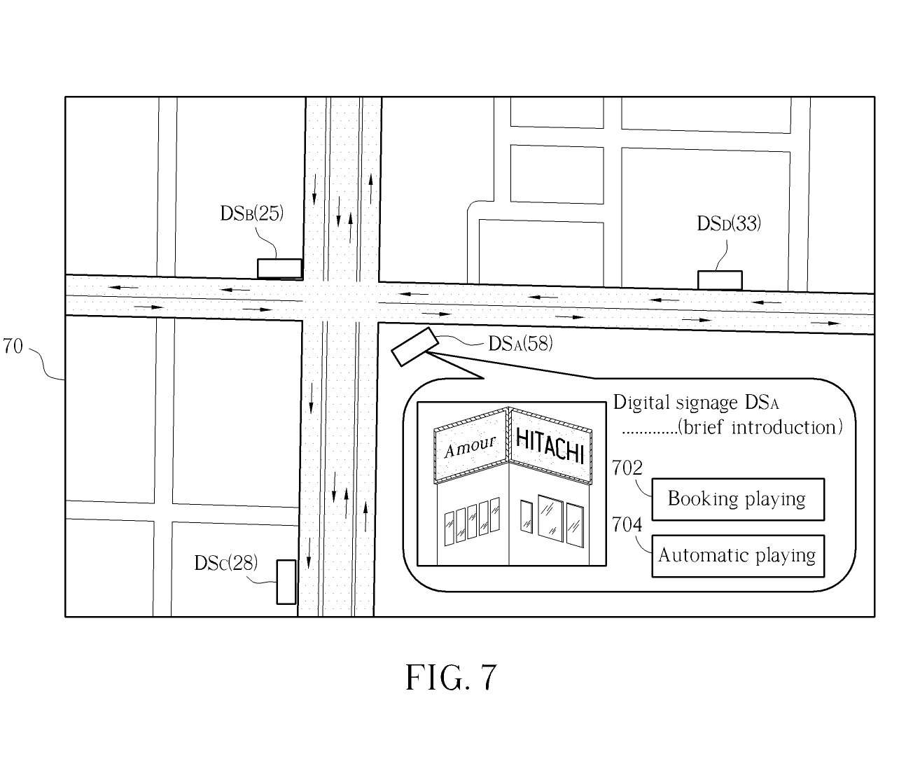

Please refer to FIG. 7, which is a schematic diagram of a map 70 according to an embodiment of the present invention. As shown in FIG. 7, locations and names of all DOOHs DS_{A}-DS_{D} within a specific area are displayed in the map 70. A parenthesis is labeled next to each of the DOOHs DS_{A}-DS_{D}. The number shown in the parenthesis means the number of audiences passing through the viewing area of the DOOH within a specific period of time. When the user 104 clicks the DOOH DS_{A} or when the user 104 places a cursor on the DOOH DS_{A}, the information related to the DOOH DS_{A} appears on the screen, and the user 104 may determine whether to play the video on the DOOH DS_{A} according to this information. The embodiments of the present invention provide two methods for playing the video: a booking playing 702 and an automatic playing 704. If the booking playing 702 is selected, the DOOH DS_{A} may be set up to play the personalized video in a predetermined time. In such a situation, the user 104 may poll the playing schedule of the DOOH DS_{A} through the server 106, in order to check bookable periods and perform the booking. If the automatic playing 704 is selected, the DOOH DS_{A} may be set up to play the personalized video when a specific audience enters the viewing area. In such a situation, a GPS system may be utilized for detecting the location, speed and/or direction of this specific audience (e.g. detecting whether this specific audience is standing still, walking, taking a vehicle, etc.). In some embodiments, some DOOHs among the DOOHs DS_{A}-DS_{D} may be marked by a symbol, in order to indicate that a personalized video has been set up on the digital signages of these DOOHs to play for the user 104. When the user 104 passes through the viewing area of the marked DOOHs DS_{A}-DS_{D}, the DOOHs DS_{A}-DS_{D} may play the personalized video automatically, where the personalized video may be designed by another user. The method of playing the video on the TV broadcasting channel is similar to the above method performed for the booking playing 702, and details are therefore not narrated herein.

In order to spread the personalized video to more people who may be interested in the video, when the user 104 selects the booking playing 702, the user 104 may announce the time and location or channel for playing the personalized video on a social networking website such as Facebook, Twitter, etc. When the personalized video is played, the user 104 may further deliver this personalized video on the social networking website simultaneously or after a specific period of time. Members of the social networking website may grade or post a judgment on the contents of this personalized video. Through the connection of people on the social networking website, the contents of the personalized video will attract more attention.

A computer-readable storage medium refers to any medium participating in providing instructions to a central processing unit (CPU) for execution. The media may take many forms, which include but are not limited to, non-volatile and volatile media such as optical or magnetic disks and dynamic memory, respectively. For example, common forms of the computer-readable storage medium include a floppy disk, a flexible disk, a hard disk, a magnetic tape, any other magnetic medium, a CD-ROM disk, a digital video disk (DVD), any other optical medium, a RAM, a PROM, an EPROM, a FLASHEPROM, and any other memory chip or cartridge.

The abovementioned DOOH refers to digital medium which are not located in home space. It usually displays the content by utilizing a digital signage. The digital signage is usually a video wall installed on an outside wall of a building, which is not limited herein. The DOOH may also be any media which play video contents in a public area, and may play the video through a TV in a building or a station. Content of the TV broadcasting media can be transmitted to TVs distributed over the world via wireless or wired networks. This video content may also be presented in other manners, which are not limited herein.

The abovementioned social networking website refers to a social networking service (SNS), which may be a service, platform or website capable of building social networks or social relations. The main function of the SNS is to set up an on-line society for a group of people having the same interest or engaging in the same activity. This kind of service is always performed via the Internet, and provides an approach for the user to perform many kinds of communication such as email, messenger, etc. The social networking website usually allows the user to share comments, activities, events, interests, etc. in his/her social network, which is not limited herein.

In the prior art, although the TV broadcasting medium has the characteristic of “broadcasting” and the DOOHs have the characteristics of “narrowcasting” and “crowd gathering”, the advertisements played on the TV broadcasting media and the DOOHs usually are often “commercial-oriented” rather than “content-oriented”. Very soon people are tired of watching them, and ignore them eventually. In comparison, the present invention combines “social networking” with the “DOOHs” or the “TV broadcasting media”, in order to compensate for the shortcomings of each other. Furthermore, the present invention personalizes the advertisement content on the DOOHs or the TV broadcasting media. Effectiveness of the advertisements are enhanced significantly due to diversification of the content (e.g. each time an advertisement is played, different content with different originality contributed by different users are broadcast, so that people may want to watch the advertisement again) and resonance of the audience (e.g. people want to watch an advertisement when a face of their friends appears in it). The present invention may also link an individual with a commercial advertisement, so that the individual will be interested in broadcasting the advertisement content through its social networks; that is, the mechanism of the present invention makes the audience more willing to distribute the advertisement because they are involved in this advertisement played on mass media. Information in the advertisement is thereby transferred more accurately (to right target audience), which further enhances the effectiveness.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of producing and playing a personalized video, comprising:
producing a plurality of video templates according to contents of a plurality of videos;
storing information corresponding to a plurality of digital out of homes (DOOHs) or a plurality of television (TV) broadcasting media and information corresponding to the plurality of video templates in a memory;
inserting a personalized content into a video template among the plurality of video templates according to the information corresponding to the plurality of video templates, in order to generate the personalized video;
playing the personalized video on a DOOH among the plurality of DOOHs or a TV broadcasting medium among the plurality of TV broadcasting media according to the information corresponding to the plurality of DOOHs or the plurality of TV broadcasting media;
announcing time and location of playing the personalized video on at least one social networking website or a channel of the TV broadcasting medium in advance before the DOOH or the TV broadcasting medium plays the personalized video; and
delivering the personalized video on the social networking website simultaneously or after a specific period of time when the personalized video is played by the DOOH or the TV broadcasting medium.

2. The method of claim 1, wherein the step of inserting the personalized content into the video template among the plurality of video templates according to the information corresponding to the plurality of video templates, in order to generate the personalized video is performed in a mobile device.

3. The method of claim 1, wherein the step of producing the plurality of video templates according to the contents of the plurality of videos comprises:
retrieving raw data from a video among the plurality of videos; and
setting at least one object in the raw data of the video to be a customizable object for inserting the personalized content, in order to generate the video template among the plurality of video templates.

4. The method of claim 1, wherein the step of playing the personalized video on the DOOH among the plurality of DOOHs or the TV broadcasting medium among the plurality of TV broadcasting media comprises controlling the DOOH or the TV broadcasting medium to play the personalized video at a predetermined time.

5. The method of claim 1, wherein the step of playing the personalized video on the DOOH among the plurality of DOOHs comprises controlling the DOOH to play the personalized video when a specific audience enters a viewing area of the DOOH.

6. The method of claim 5, further comprising detecting a location, a moving speed and a moving direction of the specific audience, in order to control the DOOH to play the personalized video when the specific audience enters the viewing area.

7. The method of claim 1, further comprising managing a playing scheduling for the plurality of DOOHs or the plurality of TV broadcasting media.

8. A non-transitory computer-readable storage medium having a program instructed by a processor to execute a method of producing and playing a personalized video, the method comprising:
producing a plurality of video templates according to contents of a plurality of videos;
storing information corresponding to a plurality of digital out of homes (DOOHs) or a plurality of television (TV) broadcasting media and information corresponding to the plurality of video templates in a memory;
inserting a personalized content into a video template among the plurality of video templates according to the information corresponding to the plurality of video templates, in order to generate the personalized video;
playing the personalized video on a DOOH among the plurality of DOOHs or a TV broadcasting medium among the plurality of TV broadcasting media according to the information corresponding to the plurality of DOOHs or the plurality of TV broadcasting media;
announcing time and location of playing the personalized video on at least one social networking website or a channel of the TV broadcasting medium in advance before the DOOH or the TV broadcasting medium plays the personalized video; and
delivering the personalized video on the social networking website simultaneously or after a specific period of time when the personalized video is played by the DOOH or the TV broadcasting medium.

9. The non-transitory computer-readable storage medium of claim 8, wherein the step of inserting the personalized content into the video template among the plurality of video templates according to the information corresponding to the plurality of video templates, in order to generate the personalized video is performed in a mobile device.

10. The non-transitory computer-readable storage medium of claim 8, wherein the step of producing the plurality of video templates according to the contents of the plurality of videos comprises:
retrieving raw data from a video among the plurality of videos; and
setting at least one object in the raw data of the video to be a customizable object for inserting the personalized content, in order to generate the video template among the plurality of video templates.

11. The non-transitory computer-readable storage medium of claim 8, wherein the step of playing the personalized video on the DOOH among the plurality of DOOHs or the TV broadcasting medium among the plurality of TV broadcasting media comprises controlling the DOOH or the TV broadcasting medium to play the personalized video at a predetermined time.

12. The non-transitory computer-readable storage medium of claim 8, wherein the step of playing the personalized video on the DOOH among the plurality of DOOHs comprises controlling the DOOH to play the personalized video when a specific audience enters a viewing area of the DOOH.

13. The non-transitory computer-readable storage medium of claim 12, further comprising executable instructions for detecting a location, a moving speed and a moving direction of the specific audience, in order to control the DOOH to play the personalized video when the specific audience enters the viewing area.

14. The non-transitory computer-readable storage medium of claim 8, further comprising executable instructions for managing a playing scheduling for the plurality of DOOHs or the plurality of TV broadcasting media.

15. A system for producing and playing a personalized video, comprising:
a template producing tool, for producing a plurality of video templates according to contents of a plurality of videos;
a memory, for storing information corresponding to a plurality of digital out of homes (DOOHs) or a plurality of television (TV) broadcasting media and information corresponding to the plurality of video templates in a memory;
a processor; and
a storage media, having a program instructed by the processor to execute the following steps:
inserting a personalized content into a video template among the plurality of video templates according to the information corresponding to the plurality of video templates, in order to generate the personalized video;
playing the personalized video on a DOOH among the plurality of DOOHs or a TV broadcasting medium among the plurality of TV broadcasting media according to the information corresponding to the plurality of DOOHs or the plurality of TV broadcasting media;
announcing time and location of playing the personalized video on at least one social networking website or a channel of the TV broadcasting medium in advance before the DOOH or the TV broadcasting medium plays the personalized video; and
delivering the personalized video on the social networking website simultaneously or after a specific period of time when the personalized video is played by the DOOH or the TV broadcasting medium.

16. The system of claim 15, wherein the step of inserting the personalized content into the video template among the plurality of video templates according to the information corresponding to the plurality of video templates, in order to generate the personalized video is performed in a mobile device.

17. The system of claim 15, wherein the step of the template producing tool producing the plurality of video templates according to the contents of the plurality of videos comprises:
retrieving raw data from a video among the plurality of videos; and
setting at least one object in the raw data of the video to be a customizable object for inserting the personalized content, in order to generate the video template among the plurality of video templates.

18. The system of claim 15, wherein the step of playing the personalized video on the DOOH among the plurality of DOOHs or the TV broadcasting medium among the plurality of TV broadcasting media comprises controlling the DOOH or the TV broadcasting medium to play the personalized video at a predetermined time.

19. The system of claim 15, wherein the step of playing the personalized video on the DOOH among the plurality of DOOHs comprises controlling the DOOH to play the personalized video when a specific audience enters a viewing area of the DOOH.

20. The system of claim 19, wherein the program is further instructed by the processor to execute instructions stored in the memory to detect a location, a moving speed and a moving direction of the specific audience, in order to control the DOOH to play the personalized video when the specific audience enters the viewing area.

21. The system of claim 15, wherein the program is further instructed by the processor to execute instructions stored in the memory to manage a playing scheduling for the plurality of DOOHs or the plurality of TV broadcasting media.
